(19) United States
(12) Patent Application Publication
(10) Pub. No.: US 2013/0176465 A1
(43) Pub. Date: Jul. 11, 2013

(54) IMAGE PICKUP APPARATUS AND METHOD OF FORMING IMAGE DATA

(71) Applicants: Katsushi Sumisaki, Osaka (JP); Erika Kawabata, Kyoto (JP); Toshihiko Taniguchi, Nara (JP)

(72) Inventors: Katsushi Sumisaki, Osaka (JP); Erika Kawabata, Kyoto (JP); Toshihiko Taniguchi, Nara (JP)

(73) Assignee: PANASONIC CORPORATION, Osaka (JP)

(21) Appl. No.: 13/821,584

(22) PCT Filed: Dec. 6, 2011
(86) PCT No.: PCT/JP2011/006810

§ 371 Date: Mar. 8, 2013

(30) Foreign Application Priority Data
Dec. 22, 2010 (JP) 2010-285602

(51) Int. Cl. H04N 5/217

(52) U.S. Cl. CPC H04N 5/217
USPC 348/241

(57) ABSTRACT

An image pickup apparatus of the present invention includes an image pickup element for imaging a subject, and an image forming section for forming image data based on image-pickup data acquired from the image pickup element. The image pickup apparatus has a first image-pickup mode of acquiring first image-pickup data in a non-emission state of light from an illuminating section to the subject, and a second image-pickup mode of acquiring second image-pickup data in an emission state of light from the illuminating section to the subject. The image forming section forms the image data by using, as a correction value for the second image-pickup data, multiplication data that is acquired by multiplying differential data calculated based on the first image-pickup data and the second image-pickup data by light-distribution correction data for smoothing the light distribution characteristic of the illuminating section.

### TECHNICAL FIELD

The present invention relates to an image pickup apparatus and a method of forming image data that are included in a mobile phone or the like having a digital still camera and a camera module, and form the image data by correcting image-pickup data of a subject illuminated by an illuminating section.

### BACKGROUND ART

It is conventionally considered to be ideal that photographing subjects with an image pickup apparatus is performed in the outdoors under clear sky where all of the subjects in the image pickup range are illuminated at uniform light quantity. This is because the sun as the light source lies at an infinite distance from each subject, and hence the sunlight uniformly comes to the subject regardless of the position and motion thereof in the image pickup range.

When a subject is photographed indoors or during the night, the sunlight is blocked and the light quantity is insufficient to photograph the subject. In order to compensate for the insufficiency of the light quantity to the subject in the image pickup range in the above-mentioned photographing environment, generally, the image pickup apparatus includes an illuminating section such as a flash device or a light emitting diode (LED) lamp for emitting auxiliary light.

The illuminating section is therefore required to uniformly illuminate a subject in the image pickup range at a light quantity equivalent to that in the outdoors under clear sky. Generally, however, the light quantity from the illuminating section varies (non-uniform) on the illuminated position because of the influence of the shape or the like of the light emitting source in the illuminating section.

Thus, a digital still camera including the following illuminating section is disclosed (for example, Patent Literature 1). The illuminating section includes a light emitting module having an LED device as the light source, and a lens array for controlling the light distribution so that the light from the LED device becomes substantially uniform in the image pickup range. The illuminating section illuminates a subject while controlling the light distribution with the lens array so that the optical paths of the light from the LED device become substantially uniform over the whole image pickup range.

In the illuminating section of Patent Literature 1, however, the configuration of the lens array is complicated. In order to completely uniform the light for illuminating a subject only with a lens array, therefore, the lens array is required to be enlarged and to have high dimensional accuracy. Realistically, the uniform illumination is impossible.

Therefore, the illumination light to a subject is not completely uniformed during the photographing, the image-pickup data obtained at that time is corrected after the photographing as if the subject had been uniformly irradiated with the illumination light (for example, Patent Literature 2).

The image correcting apparatus of Patent Literature 2 includes a digital still camera and an external electronic device. The digital still camera includes the following elements:
a flash discharge tube;
an image pickup apparatus for imaging subjects;
a photometer for detecting the luminance of a principal subject;
a range finder for measuring the distance to the principal subject;
a image-pickup data storage section for storing the image-pickup data of the subjects; and
a storage device for storing photographing information such as the distance to the principal subject and the luminance thereof. The external electronic device includes the following elements:
an interface for reading the image-pickup data and photographing information from the digital still camera;
a camera information storage device for storing camera information such as the emission amount of the flash discharge tube and the light distribution characteristic thereof; and
a central processing unit (CPU) for correcting the image-pickup data based on the photographing information and camera information.

Hereinafter, the correction of the image-pickup data in the image correcting apparatus disclosed by Patent Literature 2 is specifically described with reference to FIG. 7A through FIG. 7C.

FIG. 7A is a diagram showing the relationship between the image pickup range and the illumination range before correction in a conventional image pickup apparatus. FIG. 7B is a diagram showing the relationship between the image pickup range and the illumination range after correction in the conventional image pickup apparatus. FIG. 7C is a diagram showing the light distribution characteristic of auxiliary light before correction and after correction in the conventional image pickup apparatus. The solid line of FIG. 7C shows the light distribution characteristic of the flash discharge tube in image pickup range Q before correction of FIG. 7A. The broken line of FIG. 7C shows the light distribution characteristic of the flash discharge tube in image pickup range Q after correction of FIG. 7B.

In the light distribution characteristic of flash discharge tube 20 in image pickup range Q before correction of FIG. 7A, the light quantity is the highest at the middle position of the longitudinal direction of flash discharge tube 20, and decreases from the center toward the outer periphery as shown the solid line of FIG. 7C. At this time, the illumination range in FIG. 7C where the effective light distribution angle is between −30° and +30° , for example, corresponds to substantially elliptical illumination range R of FIG. 7A. Therefore, it is found that the light quantity in the outer periphery of illumination range R in image pickup range Q is insufficient.

The image correcting apparatus corrects the image-pickup data acquired under the photographing condition having the light distribution characteristic shown in FIG. 7A, thereby providing data having the light distribution characteristic shown in the broken line of FIG. 7C. Thus, as shown in FIG. 7B, the light quantity in illumination range R (effective light distribution angle is between −30° and +30°) of flash discharge tube 20 is made uniform in image pickup range Q based on the photographing information and camera information.

However, the image correcting apparatus disclosed by Patent Literature 2 photographs a subject with an image pickup apparatus such as the digital still camera, then corrects the image-pickup data with the external electronic device. Therefore, the image-pickup data after the correction cannot be seen on the screen of the digital still camera.

The light distribution characteristic of the flash discharge tube used for the correction by the external electronic device has a characteristic intrinsic to each image pickup apparatus. However, the image correcting apparatus uniformly corrects the image-pickup data based on the light distribution characteristic of the flash discharge tube that has been determined for an ideal subject. Therefore, it cannot be secured that each of many actual subjects existing in image pickup range Q is accurately corrected in response to the distance from each subject and the actual reflectance of each subject.

### CITATION LIST

### Patent Literature

PTL 1 Unexamined Japanese Patent Publication No. 2007-79528
PTL 2 Unexamined Japanese Patent Publication No. 2005-354167

### SUMMARY OF THE INVENTION

In order to address the above-mentioned problems, the present invention provides an image pickup apparatus that includes an image pickup element for imaging a subject and an image forming section for forming image data based on image-pickup data acquired from the image pickup element. The image pickup apparatus has a first image-pickup mode of acquiring first image-pickup data in the non-emission state of light from the illuminating section to the subject and a second image-pickup mode of acquiring second image-pickup data in the emission state of light from the illuminating section to the subject. The image forming section forms the image data by using multiplication data as the correction value for the second image-pickup data. Here, the multiplication data is acquired by multiplying differential data calculated based on the first image-pickup data and second image-pickup data by light-distribution correction data for smoothing the light distribution characteristic of the illuminating section.

Thus, an image pickup apparatus can be achieved which forms image data by uniformly correcting the light quantity of image-pickup data in response to the situation of a subject in an image pickup range.

The method of forming image data of the present invention is used in an image pickup apparatus. The image pickup apparatus includes an image pickup element for imaging a subject and an image forming section for forming image data based on image-pickup data acquired from the image pickup element. The image pickup apparatus has a first image-pickup mode of acquiring first image-pickup data in the non-emission state of light from the illuminating section to the subject and a second image-pickup mode of acquiring second image-pickup data in the emission state of light from the illuminating section to the subject. The method of forming the image data includes the steps of
acquiring the first image-pickup data and second image-pickup data;
calculating differential data based on the first image-pickup data and second image-pickup data;
calculating multiplication data by multiplying the differential data by light-distribution correction data for smoothing the light distribution characteristic of the illuminating section; and
forming the image data by using the multiplication data as the correction value for the second image-pickup data.

Thus, image data can be formed by uniformly correcting the light quantity of image-pickup data in response to the situation of a subject in an image pickup range.

### BRIEF DESCRIPTION OF DRAWINGS

FIG. 1 is a block diagram showing a configuration of an image pickup apparatus in accordance with a first exemplary embodiment of the present invention.

FIG. 2 is a flow chart showing a correcting operation of image-pickup data of the image pickup apparatus in accordance with the first exemplary embodiment.

FIG. 3A is a diagram showing an example of a digitized light distribution characteristic of a light emitting element for each pixel in an image pickup range of an image pickup element in the image pickup apparatus in accordance with the first exemplary embodiment.

FIG. 3B is a diagram showing an example of digitized light-distribution correction data for each pixel in the image pickup range in the image pickup apparatus in accordance with the first exemplary embodiment.

FIG. 3C is a diagram showing an example of digitized first image-pickup data for each pixel in the image pickup range in the image pickup apparatus in accordance with the first exemplary embodiment.

FIG. 3D is a diagram showing an example of digitized second image-pickup data for each pixel in the image pickup range in the image pickup apparatus in accordance with the first exemplary embodiment.

FIG. 4A is a diagram showing an example of digitized differential data for each pixel in the image pickup range in the image pickup apparatus in accordance with the first exemplary embodiment.

FIG. 4B is a diagram showing an example of digitized multiplication data (image correction data) for each pixel in the image pickup range in the image pickup apparatus in accordance with the first exemplary embodiment.

FIG. 4C is a diagram showing an example of digitized corrected second image-pickup data (image data) for each pixel in the image pickup range in the image pickup apparatus in accordance with the first exemplary embodiment.

FIG. 5A is a diagram showing the relationship between the image pickup range and the illumination range before correction in the image pickup apparatus in accordance with the first exemplary embodiment.

FIG. 5B is a diagram showing the relationship between the image pickup range and the illumination range after correction in the image pickup apparatus in accordance with the first exemplary embodiment.

FIG. 6 is a block diagram of an image pickup apparatus in accordance with a second exemplary embodiment of the present invention.

FIG. 7A is a diagram showing the relationship between the image pickup range and the illumination range before correction in a conventional image pickup apparatus.

FIG. 7B is a diagram showing the relationship between the image pickup range and the illumination range after correction in the conventional image pickup apparatus.

FIG. 7C is a diagram showing the light distribution characteristic of auxiliary light before correction and after correction in the conventional image pickup apparatus.

### DESCRIPTION OF EMBODIMENTS

Image pickup apparatuses of exemplary embodiments of the present invention will be described hereinafter with reference to the accompanying drawings. The present invention is not limited by the exemplary embodiments.

### First Exemplary Embodiment

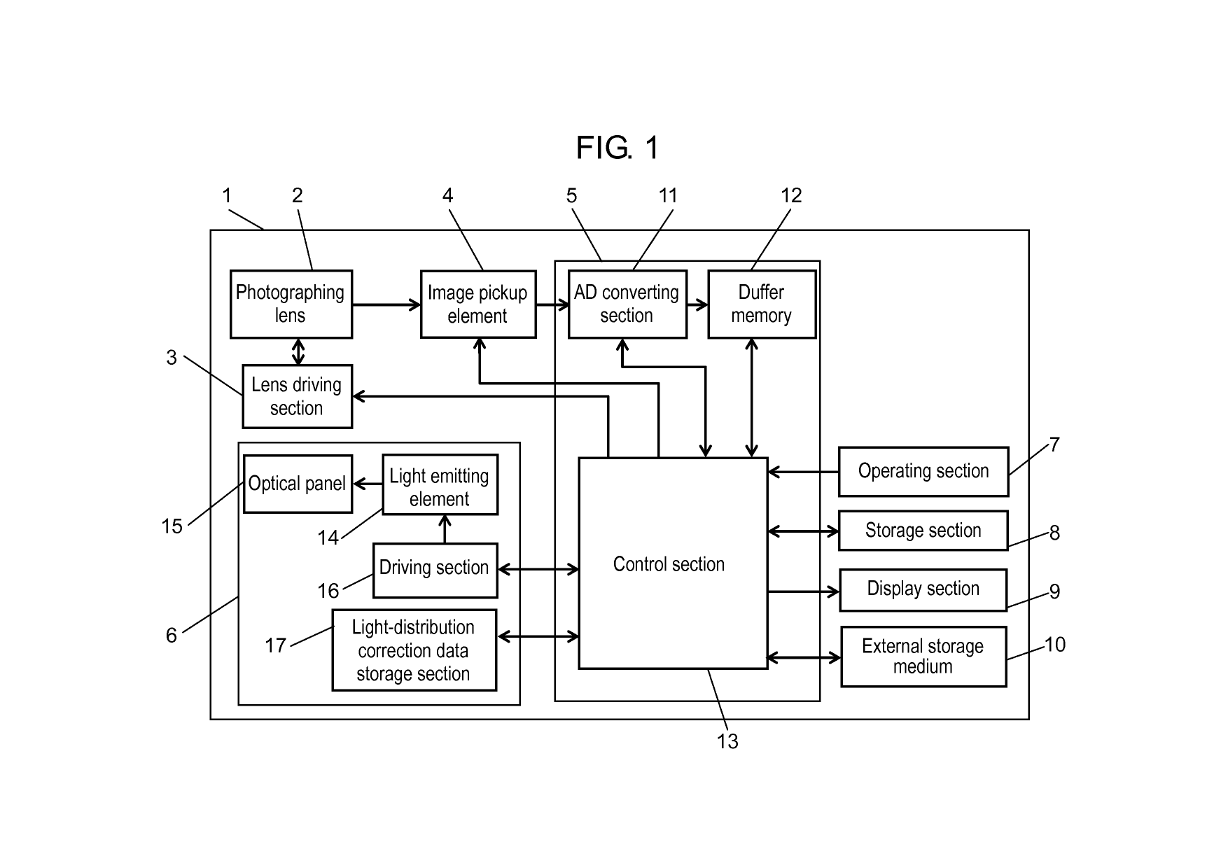

The configuration of the image pickup apparatus of the first exemplary embodiment of the present invention is described. FIG. 1 is a block diagram showing the configuration of the image pickup apparatus in accordance with the first exemplary embodiment of the present invention.

As shown in FIG. 1, image pickup apparatus 1 of the first exemplary embodiment includes at least photographing lens 2, lens driving section 3, image pickup element 4, image forming section 5, illuminating section 6, operating section 7, storage section 8, display section 9, and external storage medium 10. Photographing lens 2 is movably disposed in the optical axis direction, and is focused on a subject. Lens driving section 3 drives photographing lens 2 in the optical axis direction. Image pickup element 4 receives the reflected light from the subject via photographing lens 2 and images the subject. Image forming section 5 forms image data based on the image-pickup data acquired by image pickup element 4. Illuminating section 6 is disposed externally for example, emits light to the subject, and compensates for the light quantity emitted to the subject. Operating section 7 includes a mode switch for selecting a photographing mode and a shutter switch for opening a shutter, for example. Storage section 8 is built in the image pickup apparatus, and includes a memory such as a random access memory (RAM) or read only memory (ROM) for storing the image-pickup data and various setting conditions. Display section 9 includes a liquid crystal monitor or the like for displaying the image-pickup data and various setting conditions thereof. External storage medium 10 is constituted by a removable memory card or the like for storing the image-pickup data and various setting conditions.

Illuminating section 6 includes at least light emitting element 14, optical panel 15, driving section 16 for driving light emitting element 14, and light-distribution correction data storage section 17. Light emitting element 14 is constituted by one or more light sources such as a flash discharge tube (e.g. xenon tube) and an LED lamp, and emits light toward the subject to compensate for the light quantity to the subject. Light-distribution correction data storage section 17 is constituted by a light-distribution correction value memory or the like and stores light-distribution correction data for enabling light (auxiliary light) from light emitting element 14 to be substantially uniformly emitted to the whole image pickup range. Light-distribution correction data storage section 17 may be constituted by a read-only light-distribution correction value memory (e.g. ROM) in which light-distribution correction data is non-rewritably stored before shipment. Light-distribution correction data storage section 17 may be constituted by a readable/writable light-distribution correction value memory (e.g. RAM) in which light-distribution correction data is stored rewritably after shipment. Based on the light-distribution correction data of light-distribution correction data storage section 17, optical panel 15 shapes the light (auxiliary light) emitted from light emitting element 14 so as to substantially uniformly illuminate the whole image pickup range.

Image forming section 5 includes at least analog-to-digital (AD) converting section 11, buffer memory 12, and control section 13. AD converting section 11 converts the light reflected from the subject into a digital signal. Here, the reflected light is received as an analog signal by image pickup element 4. Buffer memory 12 temporarily stores the image-pickup data (for example, data of the digital signal converted from the reflected light) during the conversion by AD converting section 11.

Control section 13 of image forming section 5, according to the setting conditions, controls components of the image pickup apparatus such as lens driving section 3, image pickup element 4, AD converting section 11, and buffer memory 12.

A control operation of control section 13 of image forming section 5 of the present exemplary embodiment is hereinafter described.

In the present exemplary embodiment, control section 13 controls the image pickup operation in which the first image-pickup mode and second image-pickup mode are performed continuously in that sequence. At this time, control section 13 acquires the first image-pickup data in the first image-pickup mode, and then acquires the second image-pickup data in the second image-pickup mode.

In other words, control section 13 controls two different image-pickup modes, namely first image-pickup mode and second image-pickup mode, for one pickup. In the first image-pickup mode, first image-pickup data is acquired by image pickup in the non-emission state of light to the subject. In the second image-pickup mode, second image-pickup data is acquired by image pickup in the emission state of light to the subject. Based on the light distribution characteristic of illuminating section 6, control section 13 receives, from light-distribution correction data storage section 17 of illuminating section 6, light-distribution correction data used for uniformly correcting the light emitted from illuminating section 6. The light distribution characteristic of illuminating section 6 means the emission amount or emission coefficient when the subject is illuminated under a predetermined condition in the image pickup range of the image-pickup data of the subject.

Then, control section 13 acquires, from image pickup element 4, the first image-pickup data in the first image-pickup mode and the second image-pickup data in the second image-pickup mode.

Then, based on the acquired first image-pickup data and second image-pickup data, control section 13 calculates image-pickup environment correction data based on the image-pickup environment of the subject. Specifically, control section 13 calculates and acquires, as the image-pickup environment correction data, differential data that is difference in light quantity between the first image-pickup data and second image-pickup data.

Then, control section 13 calculates image correction data used for correcting the second image-pickup data, based on the differential data (image-pickup environment correction data) and the light-distribution correction data received from light-distribution correction data storage section 17 of illuminating section 6. Specifically, control section 13 calculates the image correction data by multiplying the light-distribution correction data by the differential data. Thus, the light from illuminating section 6 can be uniformly emitted to the subject in the image pickup range based on the image-pickup environment of the subject.

At this time, storage section 8 stores the following data:
the first image-pickup data and second image-pickup data acquired by image pickup element 4;
the differential data, image correction data, and corrected second image-pickup data calculated by control section 13; and
the light-distribution correction data read from light-distribution correction data storage section 17 of illuminating section 6. Storage section 8 is connected to control section 13, and transmits/receives the stored data from control section 13 in response to a control signal of control section 13.

The image pickup apparatus of the present exemplary embodiment is configured as discussed above.

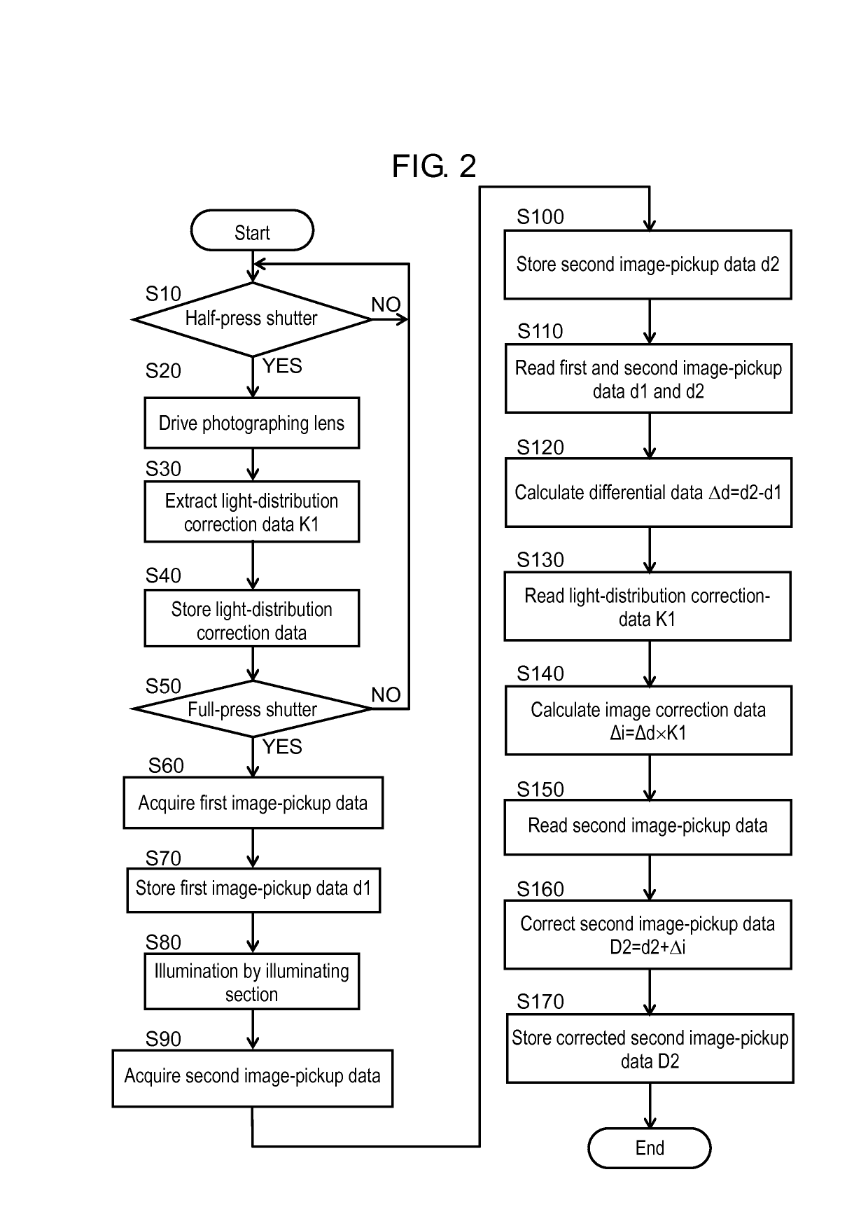

The method of forming image data of image pickup apparatus 1 of the first exemplary embodiment of the present invention is specifically described with reference to FIG. 2 through FIG. 4C.

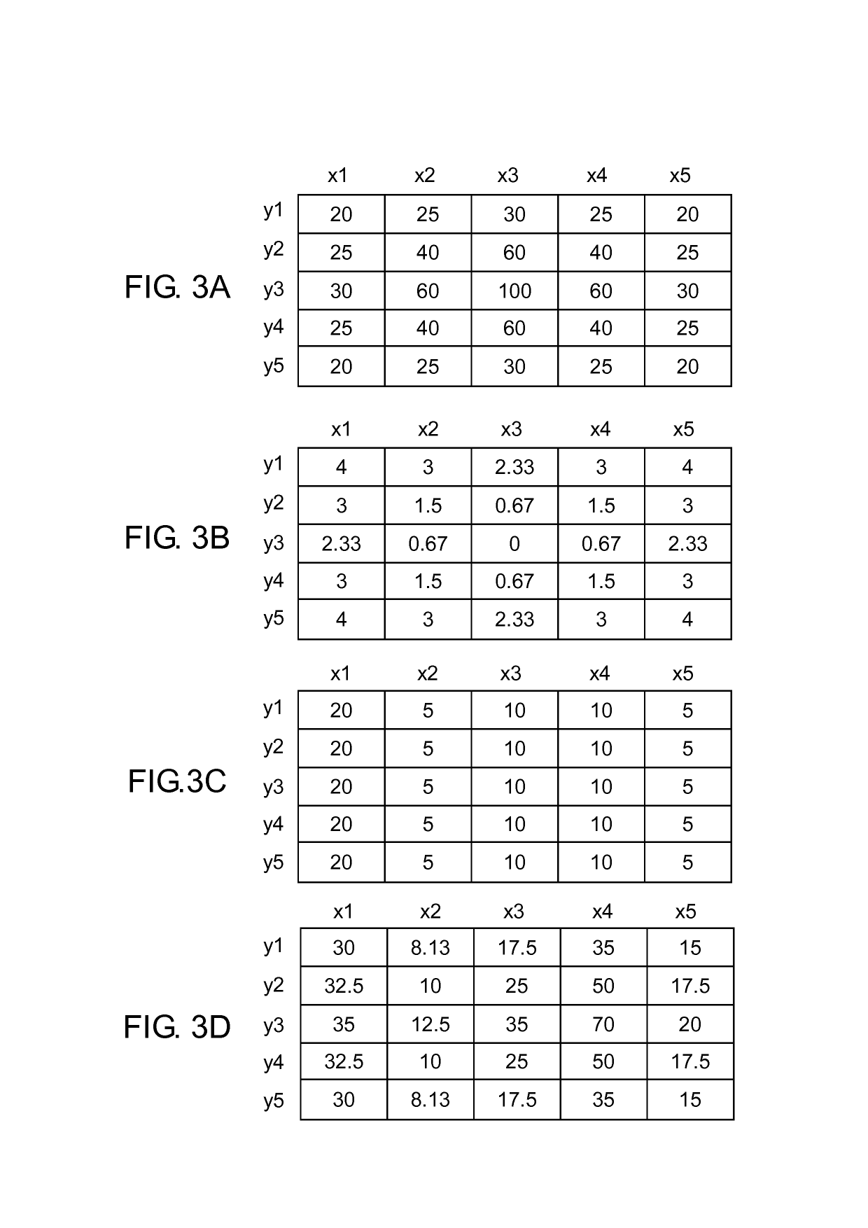

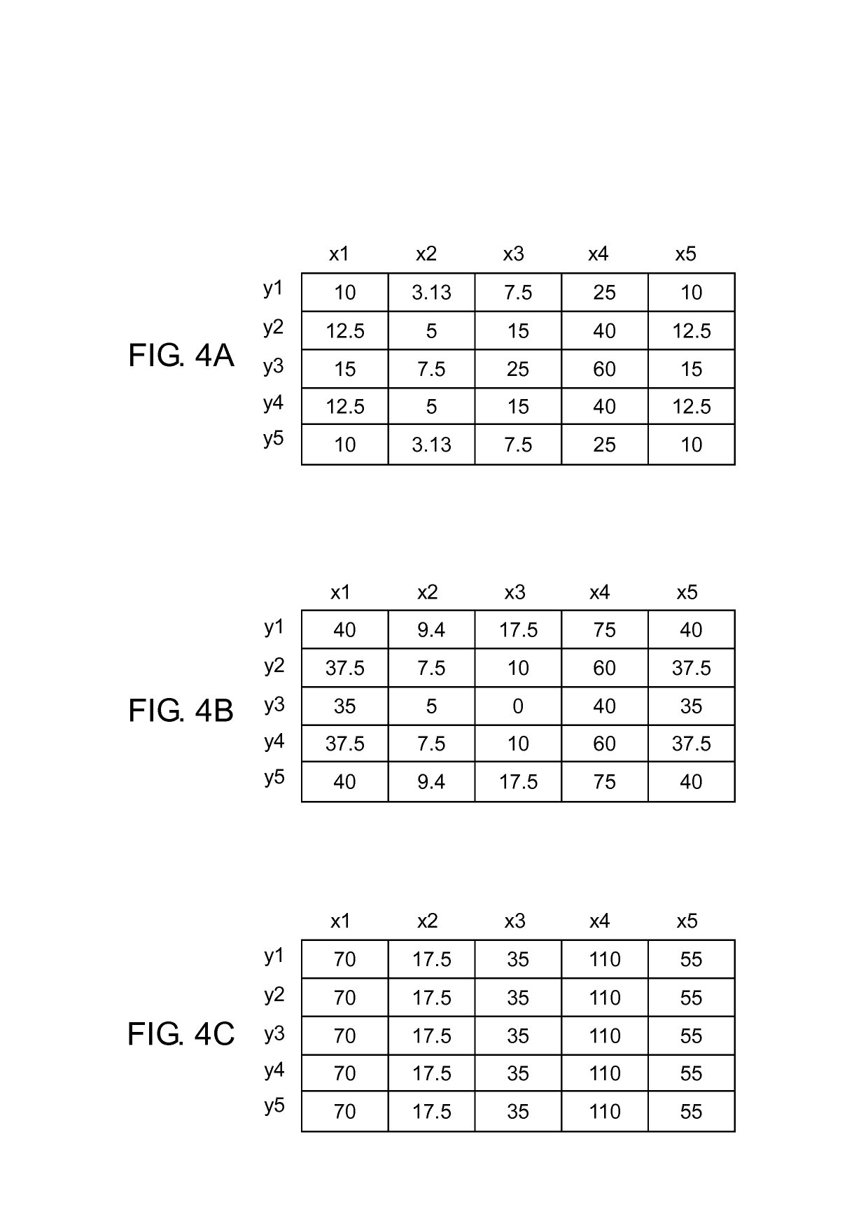

FIG. 2 is a flow chart showing the correcting operation of the image-pickup data of the image pickup apparatus in accordance with the first exemplary embodiment. FIG. 3A is a diagram showing an example of the digitized light distribution characteristic of the light emitting element for each pixel in an image pickup range of an image pickup element in the image pickup apparatus in accordance with the first exemplary embodiment. FIG. 3B is a diagram showing an example of the digitized light-distribution correction data for each pixel in the image pickup range in the image pickup apparatus in accordance with the first exemplary embodiment. FIG. 3C is a diagram showing an example of the digitized first image-pickup data for each pixel in the image pickup range in the image pickup apparatus in accordance with the first exemplary embodiment. FIG. 3D is a diagram showing an example of the digitized second image-pickup data for each pixel in the image pickup range in the image pickup apparatus in accordance with the first exemplary embodiment. FIG. 4A is a diagram showing an example of the digitized differential data for each pixel in the image pickup range in the image pickup apparatus in accordance with the first exemplary embodiment. FIG. 4B is a diagram showing an example of the digitized multiplication data (image correction data) for each pixel in the image pickup range in the image pickup apparatus in accordance with the first exemplary embodiment. FIG. 4C is a diagram showing an example of the digitized corrected second image-pickup data (image data) for each pixel in the image pickup range in the image pickup apparatus in accordance with the first exemplary embodiment.

In FIG. 3A through FIG. 4C, for simplifying the description, the image pickup range is represented as a 5-pixel (horizontal (x axis) direction) by 5-pixel (vertical (y axis) direction) array.

First, light-distribution correction data K1 required for correction of the image-pickup data is described. Light-distribution correction data K1 is calculated before shipment from the light-distribution characteristic data measured by actual light emission for each product so as to uniform the light distribution in the image pickup range. Light-distribution correction data K1 is stored in the light-distribution correction value memory of light-distribution correction data storage section 17 of illuminating section 6.

At this time, light-distribution correction data K1 is calculated for each pixel in the image pickup range that is imaged by image pickup element 4 and is formed of a plurality of ranges. Specifically, light-distribution correction data K1 is determined by dividing, by the light quantity based on light-distribution characteristic data d, the difference between the light quantity of a reference pixel and the light quantity based on light-distribution characteristic data d of illuminating section 6 for each pixel in the image pickup range. Thus, light-distribution correction data K1 indicates the relative variation of the light quantity of each pixel in the image pickup range to the light quantity of the specific pixel as the reference.

Light-distribution characteristic data d is the light quantity value of each pixel in the image pickup range that is received by image pickup element 4 when light is emitted to the subject under a specific photographing condition. The specific photographing condition means the case where the subject is under the same condition in the whole image pickup range.

The present exemplary embodiment employs the specific photographing condition where the distance from the subject is 1 m and the reflectance of the subject is 18% in the whole image pickup range. At this time, light distribution characteristic data d of illuminating section 6 acquired under this photographing condition is assumed to have the values shown in FIG. 3A. The value of each pixel in the image pickup range in FIG. 3A indicates the ratio of the light quantity of each pixel to that (assumed to be 100) of the center pixel as the reference. The value at the position of each pixel is expressed by Eq. 1.

Light-distribution characteristic data: d(x(n), y(m)) Eq. 1
n=1, 2, 3, 4, 5 m=1, 2, 3, 4, 5

In the present exemplary embodiment, the position of the pixel as the reference in the specific image pickup range is set to the position of the center pixel. At this time, the position of the center pixel corresponds to the position having the highest light quantity.

Light-distribution correction data K1 of each pixel has the value obtained by dividing, by the light quantity at the position of each pixel, the difference between the light quantity at the position of the center pixel and the light quantity at the position of each pixel. Specifically, light-distribution correction data K1 of each pixel shown in FIG. 3B is derived by substituting the light distribution characteristic data of FIG. 3A into Eq. 2.

Light-distribution correction data:

$$K 1 ( x ( n ) , y ( m ) ) = \frac{d ( x ( nc ) , y ( mc ) )}{d ( x ( n ) , y ( m ) )} - 1 \qquad Eq . 2$$

n=1, 2, 3, 4, 5 (nc=3: position of center pixel)
m=1, 2, 3, 4, 5 (mc=3: position of center pixel)
d (x(n), y(m)): light-distribution characteristic data

The correcting operation of the second image-pickup data by control section 13 is described using FIG. 2 through FIG. 4C.

In FIG. 2, first, it is determined whether the photographer has half-pressed the shutter switch (step S10). If the shutter switch has not been half-pressed (NO in step S10), the determination of step S10 is repeated until it is half-pressed.

If the shutter switch has been half-pressed (YES in step S10), control section 13 of image forming section 5 controls lens driving section 3 to drive photographing lens 2 (step S20).

Then, control section 13 of image forming section 5 extracts (downloads) light-distribution correction data K1 from the light-distribution correction value memory of light-distribution correction data storage section 17 of illuminating section 6 (step S30), and stores it into storage section 8 such as a memory (step S40). Light-distribution correction data K1 has the values shown in FIG. 3B. Thus, light-distribution correction data K1 of illuminating section 6 that is mounted on the outside of the image pickup apparatus before photographing is taken from light-distribution correction data storage section 17 to control section 13, and can be used.

Then, it is determined whether the photographer has full-pressed the shutter switch (step S50). If the shutter switch has not been full-pressed (NO in step S50), the process returns to the determination of step S10, and the operations of step 10 through step S50 are repeated until the shutter switch is full-pressed.

If the shutter switch has been full-pressed (YES in step S50), control section 13 controls image pickup element 4, acquires first image-pickup data d1 in the following photographing conditions without emitting light to the subject (step S60), and stores it into storage section 8 (step S70). The photographing conditions of the subject photographed by the photographer are as follows. When the image pickup range in the x-axis and y-axis directions is x1 through x3 and y1 through y5, the distance between image pickup apparatus 1 and the subject is set to 2 m. When the image pickup range is x4 and x5 and y1 through y5, the distance between image pickup apparatus 1 and the subject is set to 1 m. When the image pickup range is x1 and y1 through y5, the reflectance of the subject is set to 36%. When the image pickup range is x2 and x5 and y1 through y5, the reflectance of the subject is set to 9%.

When the image pickup range is x3 and x4 and y1 through y5, the reflectance of the subject is set to 18%.

First image-pickup data d1 is assumed to have the values of FIG. 3C, and is expressed by Eq. 3.

First image-pickup data: d1(x(n), y(m)) Eq. 3
n=1, 2, 3, 4, 5 m=1, 2, 3, 4, 5

Control section 13 acquires first image-pickup data d1, then controls driving section 16 of illuminating section 6 to irradiate the subject with light for compensating for the light quantity from light emitting element 14 via optical panel 15 (step S80). Then, control section 13 receives, with image pickup element 4, the light reflected from the subject irradiated at the compensated light quantity, acquires second image-pickup data d2 (step S90), and stores it into storage section 8 (step S100). At this time, for example, the values of FIG. 3D are stored as acquired second image-pickup data d2. Second image-pickup data d2 is expressed by Eq. 4. In other words, second image-pickup data d2 can be calculated based on first image-pickup data d1, distance LO from the subject, and reflectance R0 of the subject, as shown in Eq. 4.

### Second Image-Pickup Data:

$$d 2 ( x ( n ) , y ( m ) ) = {\{ \frac{L 1 ( x ( nc ) , y ( mc ) )}{L 0 ( x ( n ) , y ( m ) )} \}}^{2} \times \frac{R 1 ( x ( nc ) , y ( mc ) )}{R 0 ( x ( nc ) , y ( mc ) )} \times d ( x ( n ) , y ( m ) ) \qquad Eq . 4$$

n=1, 2, 3, 4, 5
L1(x(nc), y(mc)): distance from subject when first image-pickup data is photographed [m]
R1(x(nc), y(mc)): reflectance of subject when first image-pickup data is photographed [%]
d(x(n), y(m)): light-distribution characteristic data
L0(x(nc), y(mc)): distance from subject when light-distribution characteristic is measured [m]
R0(x(nc), y(mc)): reflectance of subject when light-distribution characteristic is measured [%]

Then, control section 13 reads, from storage section 8, first image-pickup data d1 and second image-pickup data d2 that are stored in storage section 8 (step S110). Control section 13 then calculates differential data Δd(=d2-d1), namely difference in light quantity between first image-pickup data d1 and second image-pickup data d2 (step S120). The “differential” means the case where the subtraction of the first image-pickup data from the second image-pickup data is performed, and also means the case where the subtraction is performed while at least one of the first image-pickup data and second image-pickup data is multiplied by a predetermined coefficient.

At this time, differential data Δd has the values shown in FIG. 4A, for example, and is expressed by Eq. 5.

Differential data: Δd(x(n), y(m))=d2(x(n), y(m))-d1(x(n), y(m)) Eq. 5
n=1, 2, 3, 4, 5 m=1, 2, 3, 4, 5
d1(x(n), y(m)): first image-pickup data
d2(x(n), y(m)): second image-pickup data

Then, control section 13 reads light-distribution correction data K1 from storage section 8 (step S130). Control section 13 then acquires multiplication data (image correction data) Δi(=Δd×K1) by multiplying light-distribution correction data K1 read from storage section 8 by differential data Δd calculated based on first image-pickup data d1 and second image-pickup data d2 (step S140). The “multiplication” means the case where multiplication of the first image-pickup data by the second image-pickup data is performed as it is, and also means the case where the multiplication is performed while at least one of the first image-pickup data and second image-pickup data is multiplied by a predetermined coefficient.

At this time, image correction data Δi has the values shown in FIG. 4B, for example, and is expressed by Eq. 6.

Image correction data: Δi(x(n), y(m))=Δd(x(n), y(m))×K1(x(n), y(m)) Eq. 6
n=1, 2, 3, 4, 5 m=1, 2, 3, 4, 5
Δd(x(n), y(m)): differential data
K1(x(n), y(m)): light-distribution correction data

Then, control section 13 reads second image-pickup data d2 from storage section 8 (step S150). Control section 13 then adds image correction data Δi to read second image-pickup data d2 to acquire corrected second image-pickup data D2(=d2+Δi) (step S160). Control section 13 then stores corrected second image-pickup data D2 as image data in storage section 8 (step S170). Corrected second image-pickup data D2 has the values shown in FIG. 4C, for example, and is expressed by Eq. 7.

Corrected second image-pickup data:

D2(x(n), y(m))=d2(x(n), y(m))+Δi(x(n), y(m)) Eq. 7
n=1, 2, 3, 4, 5 m=1, 2, 3, 4, 5
d2(x(n), y(m)): second image-pickup data

As discussed above, image pickup apparatus 1 of the present exemplary embodiment firstly images the subject twice under different photographing conditions, namely in the first image-pickup mode and second image-pickup mode, thereby acquiring first image-pickup data d1 and second image-pickup data d2. In the first image-pickup mode, before illuminating section 6 emits light to the subject (without illumination), the light reflected from the subject is acquired as first image-pickup data d1 from image pickup element 4. In the second image-pickup mode, after illuminating section 6 emits auxiliary light to the subject, the light reflected from the subject is acquired as second image-pickup data d2 from image pickup element 4.

Then, image forming section 5 calculates differential data Δd between first image-pickup data d1 and second image-pickup data d2 that are acquired in the above-mentioned method. Thus, differential data Δd is calculated based on the photographing environment (distance between each subject and image pickup element 4 or reflectance of the subject) where the subject is imaged actually.

Then, image forming section 5 calculates light-distribution correction data K1 based on light-distribution characteristic data d of illuminating section 6 in consideration of differential data Δd, and calculates image correction data Δi based on the photographing environment of the subject. Here, illuminating section emits light under a predetermined condition.

Then, second image-pickup data d2 is corrected using image correction data Δi to provide corrected second image-pickup data D2.

Then, based on corrected second image-pickup data D2, the light from light emitting element 14 of illuminating section 6 is emitted to the subject while the light quantity or distribution is shaped by a lens array of optical panel 15, for example.

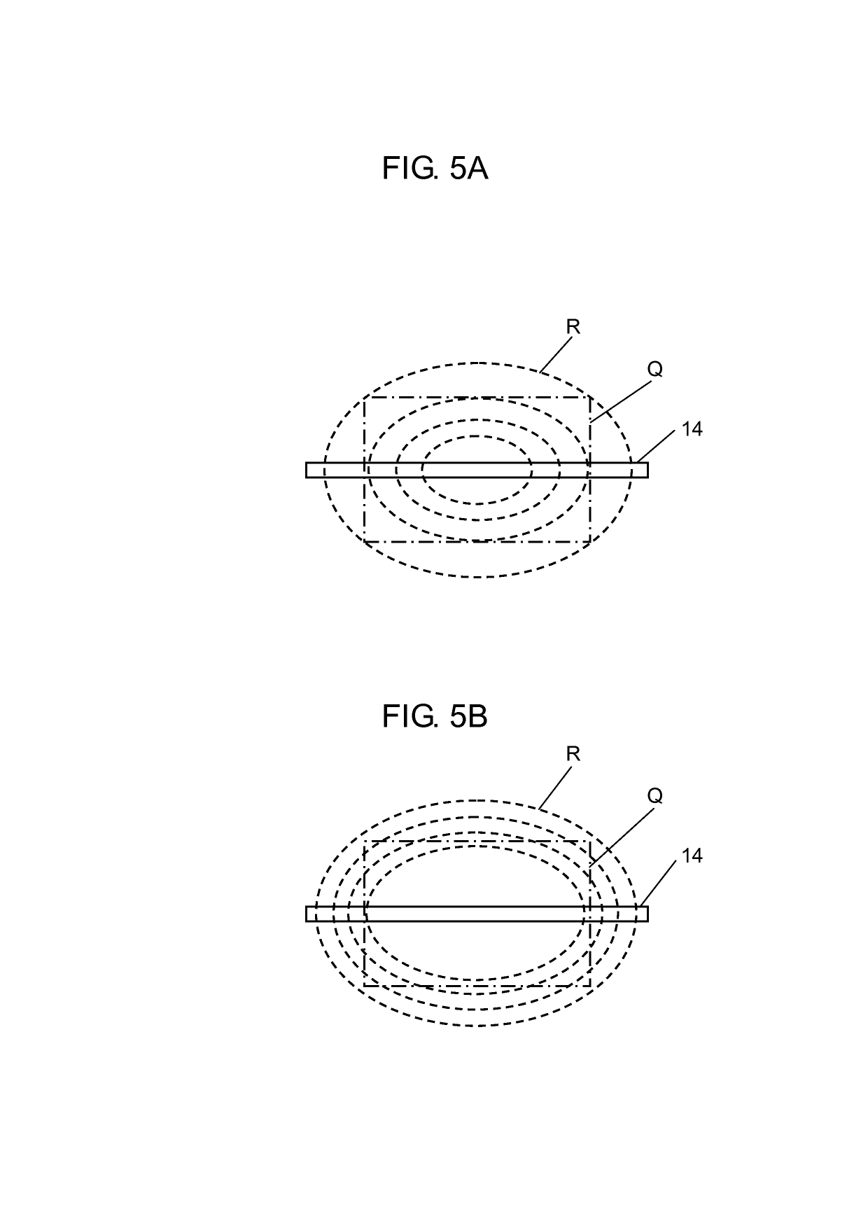

Thus, illumination range R of the light emitted to the subject in FIG. 5A can be appropriately corrected to illumination range R in FIG. 5B by correcting the light quantity of the image-pickup data, correspondingly to the photographing situation of the subject in image pickup range Q. FIG. 5A is a diagram showing the relationship between the image pickup range and the illumination range before correction in the image pickup apparatus in accordance with the first exemplary embodiment. FIG. 5B is a diagram showing the relationship between the image pickup range and the illumination range after correction in the image pickup apparatus in accordance with the first exemplary embodiment.

In other words, the present exemplary embodiment can achieve an image pickup apparatus that uniformly corrects the light quantity of the image-pickup data to form image data in response to the situation of the subject in the image pickup range.

In the present exemplary embodiment, first image-pickup data d1 of the subject in the no-afterglow state before illuminating section 6 emits light can be acquired, so that it is not required that the acquirement of the second image-pickup data is waited until the afterglow disappears. Therefore, immediately after the first image-pickup data is acquired, second image-pickup data d2 of the subject in the light emission state can be acquired. Thus, the image pickup apparatus can be achieved which forms, in a short time, image data where the light quantity of the image-pickup data is uniformly corrected.

### Second Exemplary Embodiment

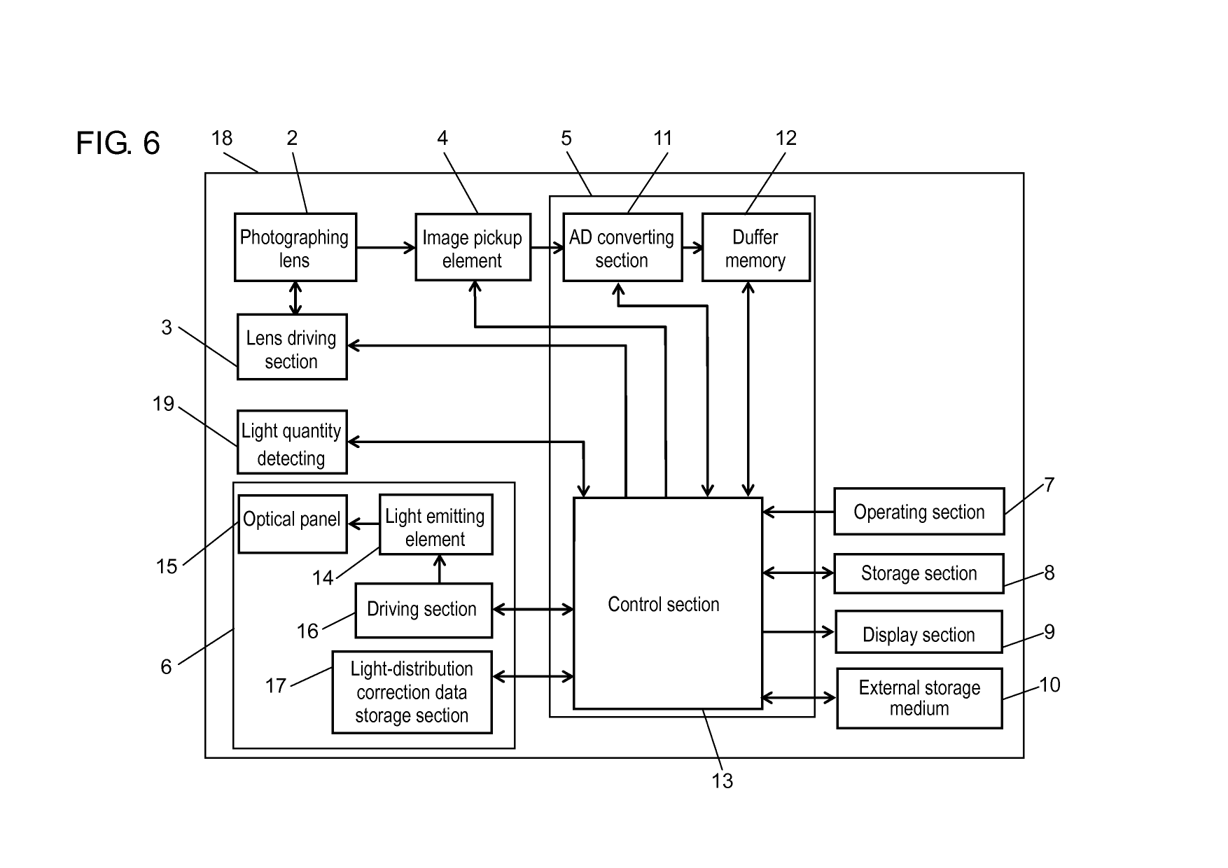

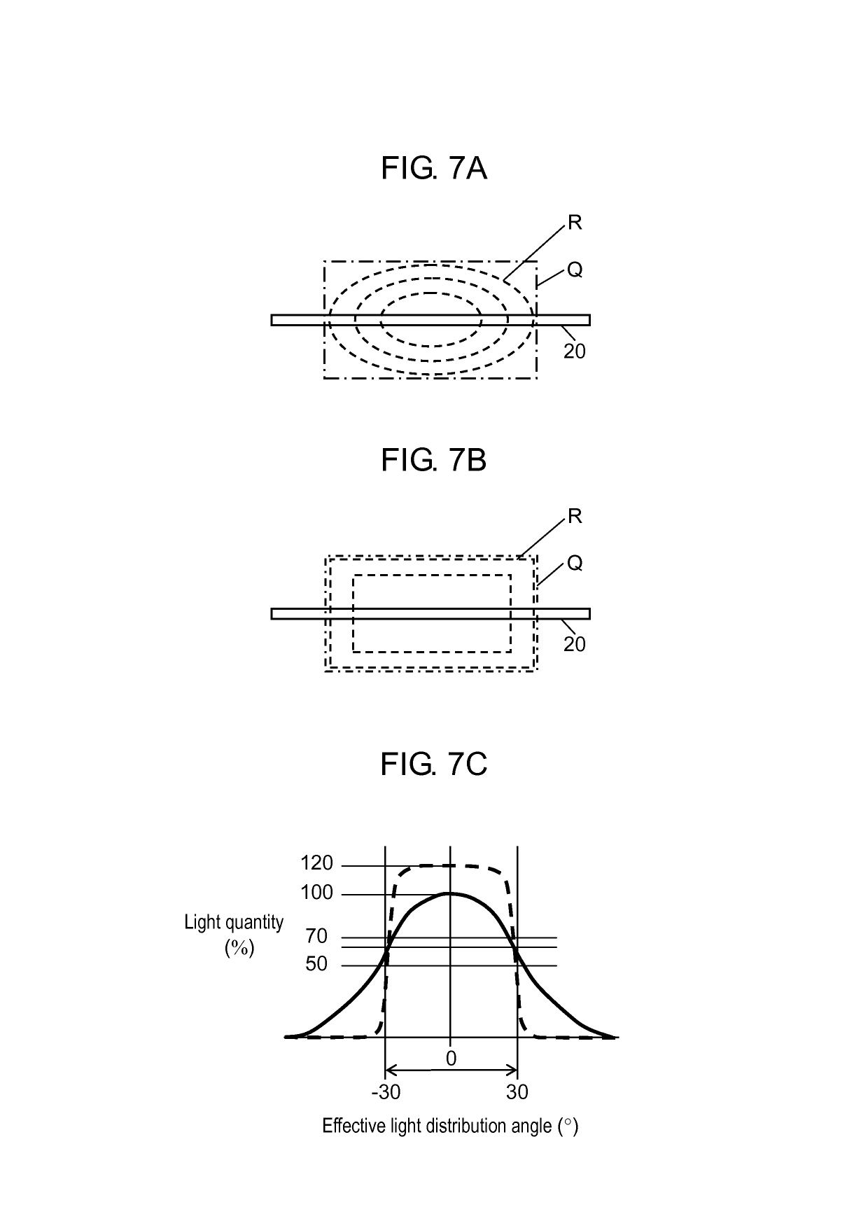

An image pickup apparatus of the second exemplary embodiment of the present invention is described hereinafter with reference to the FIG. 6.

FIG. 6 is a block diagram of the image pickup apparatus in accordance with the second exemplary embodiment of the present invention.

Image pickup apparatus 18 of the second exemplary embodiment differs from that of the first exemplary embodiment in that image pickup apparatus 18 includes light quantity detecting section 19 and acquires first image-pickup data d1 in the first image-pickup mode after acquiring second image-pickup data d2 in the second image-pickup mode. The other configuration and operation in the second exemplary embodiment are the same as those in the first exemplary embodiment, and the descriptions of them are omitted.

As shown in FIG. 6, image pickup apparatus 18 of the second exemplary embodiment includes at least photographing lens 2, lens driving section 3, image pickup element 4, image forming section 5, illuminating section 6, operating section 7, storage section 8, display section 9, external storage medium 10, and light quantity detecting section 19. Light quantity detecting section 19 detects the light quantity of the light emitted by illuminating section 6. After light quantity detecting section 19 detects that the light quantity becomes a predetermined value or lower, control section 13 acquires first image-pickup data d1.

In other words, after illuminating section 6 emits light to the subject and the second image-pickup data is acquired, and before first image-pickup data d1 is acquired, light quantity detecting section 19 detects the light quantity of the light reflected from the subject and determines a non-emission state of light to the subject. Light quantity detecting section 19 is formed of a photodiode or phototransistor, and detects that the light quantity of the light reflected from the subject is a predetermined value or lower. Light quantity detecting section 19 may be a switch or the like that is turned on or off when the light reflected from the subject has a predetermined light quantity or higher or has the predetermined light quantity or lower.

The method of forming image data of image pickup apparatus 18 of the second exemplary embodiment of the present invention is hereinafter described simply. Essentially, when the image data is formed in the second exemplary embodiment, the acquiring sequence of the first image-pickup data and second image-pickup data of the first exemplary embodiment is reversed. Therefore, the process flow that is different from that in the first exemplary embodiment is mainly described.

After illuminating section 6 emits light to the subject, image forming section 5 acquires second image-pickup data d2 from image pickup element 4.

Then, after light emission by illuminating section 6 is stopped, image forming section 5 detects the light quantity of the afterglow of the light reflected from the subject with light quantity detecting section 19. When the light quantity detected by light quantity detecting section 19 exceeds a predetermined value, image forming section 5 waits without acquiring the first image-pickup data.

When the light quantity detected by light quantity detecting section 19 becomes the predetermined value or lower, image pickup element 4 acquires first image-pickup data d1. In other words, image forming section 5 can image the subject at the acquiring timing of second image-pickup data d2 regardless of the acquirement of the first image-pickup data.

The present exemplary embodiment does not require that image forming section 5 acquires second image-pickup data d2 after it acquires first image-pickup data d1 to form image correction data (multiplication data) Δi. As a result, the acquiring timing of the second image-pickup data for imaging the subject is not late, so that the subject can be certainly imaged without missing the opportunity.

In the present exemplary embodiment, image forming section 5 detects, with light quantity detecting section 19, the acquiring timing of first image-pickup data d1 at which the light quantity of the afterglow becomes the predetermined value or lower. Image forming section 5 can thus acquire first image-pickup data d1 from image pickup element 4 at the timing when the light quantity of the afterglow becomes the predetermined value or lower. Therefore, the illuminating section illuminates the subject when second image-pickup data d2 is acquired, the afterglow of the reflected light from the subject after the illumination is stopped is prevented from exerting an influence, and first image-pickup data d1 can be certainly acquired. As a result, an image pickup apparatus can be achieved where, in order to form the image data, the light quantity for acquiring the second image-pickup data is further uniformly corrected in response to the situation of the subject in the image pickup range.

The present exemplary embodiment has described the example where image pickup apparatus 18 includes light quantity detecting section 19 and the afterglow from the subject is detected and controlled, but the present invention is not limited to this. For example, the image pickup apparatus may be configured to include a current measuring section for measuring the current value flowing in light emitting element 14 of illuminating section 6 for emitting light to the subject. In this configuration, the current measuring section detects the predetermined value or lower, and then acquires first image-pickup data d1 from image pickup element 4.

The method of acquiring first image-pickup data d1 from image pickup element 4 and forming image data when the image pickup apparatus includes the current measuring section is hereinafter described simply. The current measuring section is an ammeter for measuring light-emitting current that is used for making light emitting element 14 emit light.

After illuminating section 6 emits light to the subject, image forming section 5 firstly acquires second image-pickup data d2 from image pickup element 4.

Then, after light emission by at least illuminating section 6 is stopped, image forming section 5 detects, with the current measuring section, the light-emitting current supplied to light emitting element 14 of illuminating section 6. When the light-emitting current detected by the current measuring section exceeds a predetermined current value, image forming section 5 waits without acquiring first image-pickup data d1.

When the light-emitting current detected by the current measuring section becomes the predetermined current value or lower, image pickup element 4 acquires first image-pickup data d1. Thus, image forming section 5 can image the subject at the acquiring timing of second image-pickup data d2 similarly to the case where light quantity detecting section 19 detects and controls the light quantity.

In the image pickup apparatus that performs control based on the light-emitting current detected by the current measuring section, light emitting element 14 sometimes emits light even if the light-emitting current supplied to light emitting element 14 is substantially zero (including zero) A.

Therefore, preferably, control section 13 includes a delay circuit (timer), for example. In this case, first image-pickup data d1 is acquired after a lapse of a delay time period after the current measuring section detects the predetermined current value or lower, namely when the light quantity of the subject becomes the predetermined value or lower. Specifically, control section 13, with the delay circuit, delays a predetermined delay time period by the result of the predetermined current value or lower detected by the current measuring section, then detects that the light quantity of the subject is the predetermined value or lower, and performs control. Thus, first image-pickup data d1 can be acquired while the afterglow emitted from light emitting element 14 when the light-emitting current is zero is prevented from exerting an influence.

In the present exemplary embodiment, based on the value of the current that flows in illuminating section 6, image forming section 5 can detect, with the current measuring section, the acquiring timing of first image-pickup data d1 at which the light quantity of the afterglow becomes the predetermined value or lower. Thus, image forming section 5 can acquire first image-pickup data d1 from image pickup element 4 at the timing when the light quantity of the afterglow becomes the predetermined value or lower. Therefore, the illuminating section illuminates the subject when second image-pickup data d2 is acquired, the afterglow of the reflected light from the subject after the illumination is stopped is prevented from exerting an influence, and first image-pickup data d1 can be certainly acquired. As a result, an image pickup apparatus can be achieved which forms the image data by further uniformly correcting the light quantity for acquiring the second image-pickup data in response to the situation of the subject in the image pickup range.

The image pickup apparatus and method of forming image data of the present invention are not limited to those in the exemplary embodiments. The apparatus and method may be modified as long as they do not go out of scope of the present invention.

The present exemplary embodiment has described the image pickup apparatus that includes illuminating section 6 mounted on the outside thereof, but the present invention is not limited to this. Illuminating section 6 may be built in the image pickup apparatus. In this case, light-distribution correction data K1 may be stored in light-distribution correction data storage section 17 of illuminating section 6, or may be stored in storage section 8 such as a memory.

The present exemplary embodiment has described the image pickup apparatus that drives photographing lens 2, extracts light-distribution correction data K1 from light-distribution correction data storage section 17 of illuminating section 6, and stores it into storage section 8. However, the present invention is not limited to this. The configuration may be employed where light-distribution correction data K1 is temporarily stored into the memory of storage section 8 at the start of image pickup and is continued to be stored until illuminating section 6 is removed from the image pickup apparatus. The method may be employed where, in any one step before image correction data Δi described in FIG. 2 is calculated, light-distribution correction data K1 is extracted from light-distribution correction data storage section 17 of illuminating section 6 and is stored into storage section 8.

The present exemplary embodiment has described the image pickup apparatus that adds the multiplication data (image correction data) to the second image-pickup data to form image data. However, the present invention is not limited to this. For example, the multiplication data (image correction data) may be added to the second image-pickup data while at least one of the multiplication data (image correction data) and second image-pickup data is multiplied by a predetermined coefficient. In this case, the image data can undergo various corrections.

The present invention provides an image pickup apparatus that includes an image pickup element for imaging a subject and an image forming section for forming image data based on image-pickup data acquired from the image pickup element. The image pickup apparatus has a first image-pickup mode of acquiring first image-pickup data in the non-emission state of light from the illuminating section to the subject and a second image-pickup mode of acquiring second image-pickup data in the emission state of light from the illuminating section to the subject. The image forming section forms the image data by using multiplication data as the correction value for the second image-pickup data. Here, the multiplication data is acquired by multiplying differential data calculated based on the first image-pickup data and second image-pickup data by light-distribution correction data for smoothing the light distribution characteristic of the illuminating section.

In this configuration, the image pickup apparatus images the subject twice under different conditions, namely in the first image-pickup mode and second image-pickup mode. In the first image-pickup mode, the image forming section acquires the first image-pickup data from the image pickup element in the non-emission state of light from the illuminating section to the subject. In the second image-pickup mode, the image forming section acquires the second image-pickup data from the image pickup element in the emission state of light from the illuminating section to the subject.

Then, the image forming section forms differential data by taking difference between the first image-pickup data and second image-pickup data. Thus, photographing environment correction data is calculated based on the photographing environment (distance between each subject and the image pickup element or reflectance of the subject) where the subject is imaged actually.

Then, the image forming section calculates image correction data based on the photographing environment of the subject using the multiplication data that is obtained by multiplying the differential data (photographing environment correction data) by the light-distribution correction data for smoothing the light distribution characteristic of the illuminating section in the image pickup range. Here, the light-distribution correction data is required for smoothing the light distribution characteristic of the illuminating section when it is assumed that the light from the illuminating section is uniformly emitted to the image pickup range.

The image forming section corrects the second image-pickup data by using the multiplication data (image correction data) as the correction value, thereby forming the image data having uniform light quantity.

Thus, an image pickup apparatus can be achieved which forms image data by uniformly correcting the light quantity of image-pickup data in response to the situation of the subject in the image pickup range.

An image forming section of the image pickup apparatus of the present invention is configured to acquire the second image-pickup data after acquired the first image-pickup data.

In this configuration, the image forming section can acquire first image-pickup data d1 of the subject in the no-afterglow state before illuminating section 6 emits light, so that it is not required that the acquirement of the second image-pickup data is waited until the afterglow disappears. Therefore, immediately after the first image-pickup data is acquired, second image-pickup data d2 of the subject in the light emission state can be acquired. Thus, the image pickup apparatus can be achieved which forms, in a short time, image data where the light quantity of image-pickup data is uniformly corrected.

An image forming section of the image pickup apparatus of the present invention is configured to acquire the first image-pickup data after acquired the second image-pickup data.

In this configuration, the image forming section acquires second image-pickup data from the image pickup element in the emission state of light from the illuminating section to the subject. Then, the image forming section acquires the first image-pickup data after the light quantity of the afterglow becomes a predetermined value or lower at which the afterglow does not exert an influence. The image forming section can therefore image the subject at the acquiring timing of the second image-pickup data. Therefore, it is not required that the second image-pickup data is acquired after the first image-pickup data is acquired in order to form the image correction data (multiplication data). As a result, the acquiring timing of the second image-pickup data for imaging the subject is not late, so that the subject can be certainly imaged without missing the pickup opportunity.

An image pickup apparatus of the present invention further includes a light quantity detecting section for detecting the light quantity of the light emitted by the illuminating section. After the light quantity detecting section detects the predetermined light quantity or lower, the image forming section acquires the first image-pickup data.

In this configuration, the image forming section detects, with the light quantity detecting section, the acquiring timing of the first image-pickup data at which the light quantity of the afterglow becomes the predetermined value or lower. The image forming section can thus acquire the first image-pickup data from the image pickup element at the timing when the light quantity of the afterglow becomes the predetermined value or lower. Therefore, the illuminating section illuminates the subject when the second image-pickup data is acquired, the afterglow of the reflected light from the subject after the illumination is stopped is prevented from exerting an influence, and the first image-pickup data can be certainly acquired.

An image pickup apparatus of the present invention further includes a current measuring section for measuring the value of the current flowing in the illuminating section when the illuminating section emits light. After the current measuring section detects a predetermined current value or lower, the image forming section acquires the first image-pickup data.

In this configuration, based on the current value of the light-emitting current that flows in the illuminating section, the image forming section can detect, with the current measuring section, the acquiring timing of the first image-pickup data at which the light quantity of the afterglow becomes the predetermined value or lower. Thus, the image forming section can acquire the first image-pickup data from the image pickup element at the timing when the light quantity of the afterglow becomes the predetermined value or lower. Therefore, the illuminating section illuminates the subject when the second image-pickup data is acquired, the afterglow of the reflected light from the subject after the illumination is stopped is prevented from exerting an influence, and the first image-pickup data can be certainly acquired.

The present invention provides a method of forming image data in an image pickup apparatus. The image pickup apparatus includes an image pickup element for imaging a subject and an image forming section for forming image data based on the image-pickup data acquired from the image pickup element. The image pickup apparatus has a first image-pickup mode of acquiring the first image-pickup data in the non-emission state of light from the illuminating section to the subject and a second image-pickup mode of acquiring the second image-pickup data in the emission state of light from the illuminating section to the subject. The method of forming the image data includes the steps of
acquiring the first image-pickup data and second image-pickup data;
calculating differential data based on the first image-pickup data and second image-pickup data;
calculating multiplication data by multiplying the differential data by light-distribution correction data for smoothing the light distribution characteristic of the illuminating section; and
forming the image data by using the multiplication data as the correction value for the second image-pickup data.

Thus, image data can be formed by uniformly correcting the light quantity of image-pickup data in response to the situation of the subject in the image pickup range.

### INDUSTRIAL APPLICABILITY

The image pickup apparatus and the method of forming image data of the present invention are useful in the technological field such as a mobile phone or a small electronic device including a digital still camera and a camera module.

### REFERENCE MARKS IN THE DRAWINGS

1 image pickup apparatus
2 photographing lens
3 lens driving section
4 image pickup element
5 image forming section
6 illuminating section
7 operating section
8 storage section
9 display section
10 external storage medium
11 AD converting section
12 buffer memory
13 control section
14 light emitting element
15 optical panel
16 driving section
17 light-distribution correction data storage section
18 image pickup apparatus
19 light quantity detecting section
20 flash discharge tube
d light-distribution characteristic data
d1 first image-pickup data
d2 second image-pickup data
K1 light-distribution correction data
Δd differential data
Δi multiplication data (image correction data)
D2 corrected second image-pickup data (image data)

1. An image pickup apparatus comprising:
an image pickup element for imaging a subject; and
an image forming section for forming image data based on image-pickup data acquired from the image pickup element,
the image pickup apparatus having:
a first image-pickup mode of acquiring first image-pickup data in a non-emission state of light from an illuminating section to the subject; and
a second image-pickup mode of acquiring second image-pickup data in an emission state of light from the illuminating section to the subject,
wherein the image forming section forms the image data by using multiplication data as a correction value for the second image-pickup data, the multiplication data being acquired by multiplying differential data calculated based on the first image-pickup data and the second image-pickup data by light-distribution correction data for smoothing a light distribution characteristic of the illuminating section.

2. The image pickup apparatus of claim 1, wherein
the image forming section acquires the second image-pickup data after acquired the first image-pickup data.

3. The image pickup apparatus of claim 1, wherein
the image forming section acquires the first image-pickup data after acquired the second image-pickup data.

4. The image pickup apparatus of claim 3, further comprising a light quantity detecting section for detecting a light quantity of light emitted by the illuminating section,
wherein the image forming section acquires the first image-pickup data after the light quantity detecting section detects a predetermined light quantity or lower.

5. The image pickup apparatus of claim 3, further comprising a current measuring section for measuring a value of current flowing in the illuminating section when the illuminating section emits light,
wherein the image forming section acquires the first image-pickup data after the current measuring section detects a predetermined current value or lower.

6. A method of forming image data in an image pickup apparatus, the image pickup apparatus including an image pickup element for imaging a subject and an image forming section for forming the image data based on image-pickup data acquired from the image pickup element, the image pickup apparatus having a first image-pickup mode of acquiring first image-pickup data in a non-emission state of light from an illuminating section to the subject and a second image-pickup mode of acquiring second image-pickup data in an emission state of light from the illuminating section to the subject,
the method comprising:
acquiring the first image-pickup data and the second image-pickup data;
calculating differential data based on the first image-pickup data and the second image-pickup data;
calculating multiplication data by multiplying the differential data by light-distribution correction data for smoothing a light distribution characteristic of the illuminating section; and
forming the image data by using the multiplication data as a correction value for the second image-pickup data.
